(19) United States
(12) Patent Application Publication
(10) Pub. No.: US 2026/0194915 A1
(43) Pub. Date: Jul. 9, 2026

(54) System for Controlling Vehicle Advancement Based on Passive Hand Tracking

(71) Applicant: Brigham Young University (BYU), Provo, UT (US)

(72) Inventors: Douglas Cook, Fountain Green, UT (US); Jeffrey Taylor, Springville, UT (US)

(21) Appl. No.: 19/443,950

(22) Filed: Jan. 8, 2026

Related U.S. Application Data
(60) Provisional application No. 63/743,087, filed on Jan. 8, 2025.

(51) Int. Cl. G05D 1/648; G05D 1/2285; G05D 105/15; G05D 111/10

(52) U.S. Cl. CPC G05D 1/6484; G05D 1/2285; G05D 2105/15; G05D 2111/17

(57) ABSTRACT

An agricultural vehicle includes a mobile chassis having a motorized drive system configured to traverse an agricultural environment and a support platform coupled to the mobile chassis to support an operator during an agricultural activity. A sensor system is coupled to the mobile chassis and captures data corresponding to a workspace zone accessible to the operator. A controller is in communication with the motorized drive system and the sensor system and is configured to detect a spatial position of at least one portion of the operator within the workspace zone, determine a displacement of the spatial position relative to a reference configuration, and generate a control signal to adjust a navigational parameter of the mobile chassis based on the displacement to maintain a spatial relationship between the portion and a target region of the workspace zone.

### CROSS-REFERENCE TO RELATED APPLICATION

This application claims benefit, under 35 U.S.C. § 119, of U.S. Provisional Patent Application No. 63/743,087, filed on January 8, 2025, entitled “Adaptive Harvesting Cart: A Self-Propelled Solution for Efficient Crop Collection”, the disclosure of which is incorporated by reference herein in its entirety.

### BACKGROUND

Agricultural tasks (e.g., harvesting, thinning, weeding, etc.,) for delicate and/or low-to-the-ground crops, such as strawberries, asparagus, and saffron, involves manual labor that includes repetitive bending, stooping, or crawling. These postures are associated with physical strain, which may lead to worker fatigue and a risk of musculoskeletal disorders. To address these ergonomic challenges, mobile platforms have been developed to support an operator in a prone position, allowing the operator to reach the crops while lying face-down.

### SUMMARY

This disclosure describes a mobile agricultural vehicle and a method for regulating vehicle advancement that utilizes passive anatomical tracking to coordinate movement in conjuction with tasks performed by a human. The vehicle includes a mobile chassis and a motorized drive system configured to traverse an agricultural environment. A support platform is coupled to the mobile chassis to support an operator during these tasks. A sensor system captures data corresponding to a workspace zone accessible to the operator, and a controller manages the navigational parameters of the mobile chassis based on this data. By detecting a spatial position of at least one portion (e.g., anatomical feature) of the operator, such as a hand or wrist, and determining a displacement of that position relative to a reference configuration, the controller can generate control signals to adjust the vehicle's navigation. This adjustment facilitates maintaining a substantially constant spatial relationship between the operator's anatomical features and a target region of the workspace zone, allowing the vehicle to advance or retract in an intuitive manner that responds to the real-time pace of the activity.

The system is designed to provide a technical solution to the ergonomic and cognitive challenges associated with manual agricultural tasks. By deriving navigational commands from the natural working motions of the operator, the vehicle obviates discrete manual control inputs such as foot pedals or hand-operated levers. This passive visual servoing architecture reduces the physical strain and coordination of the operator, enabling a focus on high-dexterity tasks. In some implementations, the support platform is configured to support the operator in a prone position to further mitigate musculoskeletal fatigue. Additionally, the system may implement a hysteresis threshold or dead band associated with the reference configuration to filter out minor physiological fluctuations or transient motions, thereby preventing mechanical oscillation and ensuring smooth vehicle movement.

The controller may be configured to determine a displacement by a predetermined amount or relative to a spatial position of a subject crop being worked upon. Navigational parameters, such as a forward velocity, can be regulated to be proportional to the magnitude of the detected displacement. To ensure operational stability, the controller may calculate a detected average hand position over a predetermined time period, which may be derived from a centroid of the operator's hands. The sensor system can involve various modalities, including optical cameras, stereo camera pairs, time-of-flight sensors, or magnetic field sensors. In some examples, a wheel encoder provides odometry data as a feedback signal to verify and refine navigational adjustments. Further implementations include a solar array for capturing solar radiation to power the drive system while providing environmental shielding for the operator, and front-facing sensors configured to capture data corresponding to crop rows, landmarks, or obstacles to facilitate path-following navigation.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 is a perspective view of an agricultural vehicle supporting an operator in a prone position while traversing an agricultural environment.

FIG. 2 is a schematic representation of a sensor system and control architecture integrated with a mobile chassis to capture data corresponding to the agricultural environment and the operator.

FIG. 3 is a perspective view of an agricultural vehicle comprising an integrated solar array that provides electrical energy and environmental shielding.

FIG. 4 is a schematic diagram illustrating the control logic implemented by a controller to adjust a navigational parameter based on a detected displacement of an portion relative to a reference configuration.

FIG. 5 is a flow diagram illustrating a method for regulating the advancement of an agricultural vehicle.

FIG. 6 is a block diagram illustrating a computing system that can be used to implement the controller and associated navigational logic.

It should be noted that these Figures are intended to illustrate the general characteristics of methods, and/or structures utilized in some example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

The present disclosure relates to mobile agricultural vehicles and associated control systems for use in performing tasks that require manual dexterity. Existing prone carts include a motorized drive system to advance the cart through a field. In various systems, the advancement and steering of the vehicle are managed through manual inputs, such as foot pedals, joysticks, or hand-operated levers. However, these control mechanisms introduce technical and ergonomic complexities. Operating foot pedals while in a prone position involves a high degree of physical coordination and can cause muscular tension in the legs and lower back, which may diminish the ergonomic utility of the prone platform.

Furthermore, manual controls increase the cognitive load on the operator. The operator simultaneously manages the dexterity-intensive task of manipulating delicate crops or weeds while also tracking the position of the vehicle and providing discrete mechanical inputs to adjust the speed or direction of the cart. This dual-task configuration often results in inconsistent advancement speeds, where the cart may move too quickly for a dense patch of the objects of interest or too slowly when objects of interest are sparse, leading to reduced efficiency.

While some agricultural vehicles employ automated navigation based on pre-planned GPS paths or row-following sensors, these systems generally lack the responsiveness to adapt to the real-time pace of a manual operation. Such systems typically operate at a constant speed or involve the operator manually triggering a stop or start command using a button or a specific gesture. These discrete interactions interrupt the natural flow of the worker’s motion, further limiting the potential for increasing the rates at which tasks can be performed. Accordingly, there is a technical challenge for a control system that can regulate vehicle advancement in a manner that is intuitively coupled with the natural movements of an operator without involving discrete manual control inputs.

The systems described herein are directed to a self-propelled agricultural task platform configured to support an operator while traversing an agricultural environment and performing manual harvesting tasks. Conventional harvesting or weeding platforms typically involve an operator to regulate vehicle movement using discrete manual controls, such as pedals, levers, or switches, which can impose physical strain, increase cognitive load, and limit the ability of the vehicle to adapt to variations in pace and task density. As a result, vehicle advancement may become decoupled from the natural motions of the operator, reducing operational efficiency and ergonomic benefit. The present application addresses these technical limitations by describing systems in which vehicle navigation is adjusted in response to sensed spatial characteristics associated with the operator and the workspace, enabling coordinated movement of the vehicle that is responsive to real-time activity without requiring dedicated manual control inputs.

In one implementation, a system for managing the advancement of an agricultural vehicle involves a coordinated integration of a mobile chassis, a sensor array, and a computational controller. The systems and methods described herein provide a technical solution to the mechanical and cognitive challenges associated with manual of low-growing crops. By deriving navigational control signals from the spatial relationship between an operator and a workspace, the vehicle facilitates an ongoing operation without involving discrete manual inputs. While the following description may reference specific agricultural subjects, sometimes referred to herein as subject crops, such as saffron or berries, these references serve as non-limiting examples of biological subjects that involve high-dexterity manual interaction. The technical principles disclosed are applicable to a variety of supportive configurations, including platforms that support an operator in a prone, seated, or standing orientation relative to a ground surface.

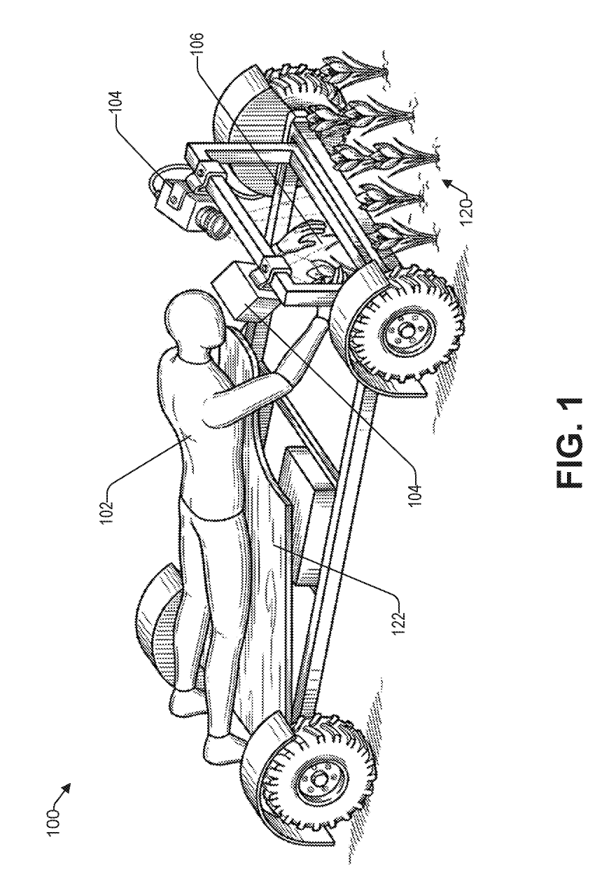

FIG. 1 illustrates a perspective view of an agricultural vehicle 100 configured to facilitate the collection of subject crops 120, such as saffron flowers, consistent with an illustrative implementation. The vehicle 100 includes a mobile chassis supported by a motorized drive system, illustrated here as a plurality of wheels. While four wheels are illustrated in the example of FIG. 1, it will be understood that any number of wheels or tracks are supported by the teachings herein. A support platform 122 is coupled to the mobile chassis and is configured to support an operator 102 in a prone position. This orientation allows the operator 102 to access a workspace zone located beneath or forward of the support platform.

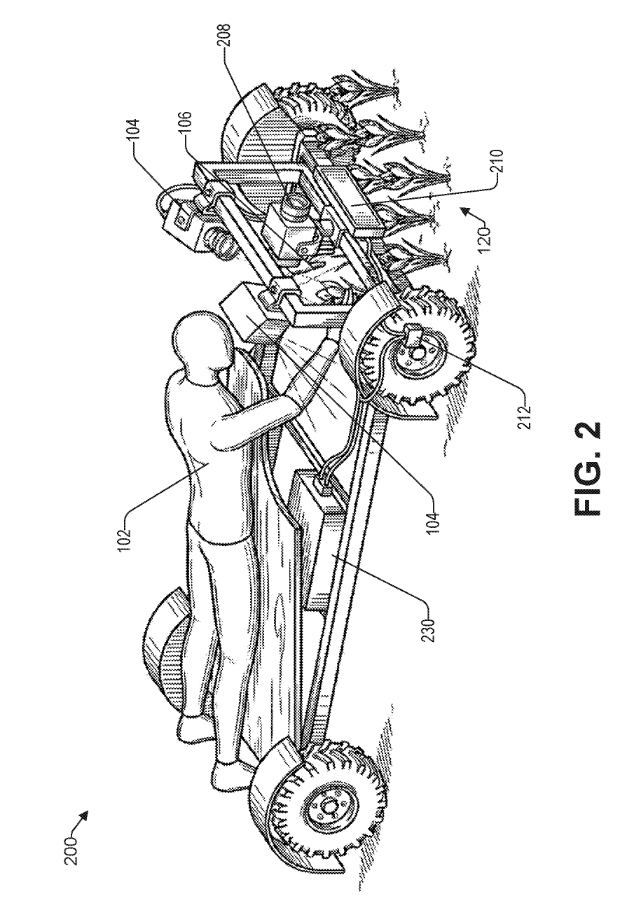

A sensor system is coupled to the mobile chassis. In the illustrated implementation, the sensor system in the example of FIG. 1 includes a camera system, such as an optical sensor 104, comprising one or more cameras positioned to capture data corresponding to the workspace zone. The sensor system is configured to capture data corresponding to a spatial position of at least one portion (e.g., anatomical feature) 106 of the operator 102, including the hands or wrists, during interaction with the subject crops 120. As described in further detail with respect to FIG. 2, the sensor system may involve various configurations, including stereo vision or wide-angle arrays, to track the spatial position of the portions 106. The data captured by the sensor system is processed to adjust a navigational parameter of the vehicle 100 based on the displacement of the at least one portion 106 relative to a reference configuration.

FIG. 2 illustrates a schematic representation of a sensor system and control architecture 200 integrated with a mobile chassis. The sensor system (e.g., 104, 106, 208, 210) involves a plurality of sensor types configured to track both the agricultural environment and the operator to facilitate responsive navigation. In one implementation, the sensor system involves at least one optical sensor 104, such as a camera, operative to identify a position of at least one hand of the operator within the workspace zone. In various implementations, the optical sensor 104 may involve a monocular camera, a stereo camera pair, or a time-of-flight (ToF) camera capable of capturing depth information. For example, a ToF camera can emit modulated light (e.g., by infrared) into the workspace. The reflected light from objects (e.g., the operator’s hands, wrist, or crops) can be used to calculate the distance based on the time delay or phase shift between emitted and reflected light. This allows the system to compute a depth value for each pixel, producing a depth map that directly encodes spatial position relative to the camera.

In one implementation, a front-facing sensor 208 is configured to capture data corresponding to an area forward of the vehicle, such as a subsequent row of subject crops 120 or a pre-planned path. This front-facing sensor 208 facilitates environmental data gathering and path-following navigation, allowing the controller 230 to identify crop rows, landmarks, or potential obstacles. In some implementations, the front-facing sensor 208 captures image data that is processed to recognize landmarks at the end of a row or to assess the maturity of subject crops 120. Additionally, the front-facing sensor 208 may facilitate localization by integrating visual data with satellite-based positioning systems to maintain the vehicle along a determined trajectory.

In one implementation, the system further includes a wheel encoder 212 (which may involve an integrated motor/encoder unit) coupled to a wheel assembly of the motorized drive system. The wheel encoder 212 is configured to generate odometry data for the controller 230 by measuring the rotation of one or more wheels to calculate a distance traveled by the mobile chassis. The controller 230 utilizes this odometry data to provide navigation support, such as by estimating a vehicle position between updates from a satellite-based positioning system (e.g., global positioning system (GPS) or real-time kinematic GNSS). In one implementation, the controller 230 implements a motion model, such as an unscented Kalman filter, to integrate the odometry data with satellite data and data from an inertial measurement unit (IMU) to facilitate persistent tracking of a crop row. Furthermore, the wheel encoder 212 provides a feedback signal to the controller 230 to regulate speed control. This feedback loop enables the controller 230 to verify that the mobile chassis is traversing the environment at a velocity that is substantially proportional to a velocity regulated by the hand-tracking logic, facilitating the physical advancement of the vehicle to be synchronized with the detected displacement of the operator's hands.

Alternative implementations of the sensor system involve non-optical sensors in addition to or instead of the optical sensors discussed herein, for detecting the operator's hand position. For example, a magnetic sensor, such as a Hall Effect sensor, may be employed to detect a magnetic field generated by a magnetic element worn on a wrist or glove of the operator. Additionally, the system may involve light detection and ranging (LIDAR) sensors, RADAR sensors, or ultrasonic sensors 210 for measuring distance to the operator's hands, detecting obstacles, or implementing safety interlocks. The sensor system further includes crop-specific sensors, such as multispectral cameras, to identify crop maturity or health. In some environments, such as pre-dawn harvesting or other agricultural activity, artificial lighting is provided to facilitate consistent performance of the sensor system. In addition to optical sensors, the sensor system includes a navigation array for path planning and row following. This array may involve a global positioning system (GPS) receiver or a real-time kinematic (RTK) GNSS module for high-precision localization. An inertial measurement unit (IMU), such as a 9-degree-of-freedom IMU, is provided to detect the pitch, roll, and yaw of the mobile chassis, enabling the controller 230 to compensate for uneven terrain. Furthermore, wheel encoders 212 or motor units coupled to the motorized drive system provide odometry data to estimate travel distance between satellite positioning updates.

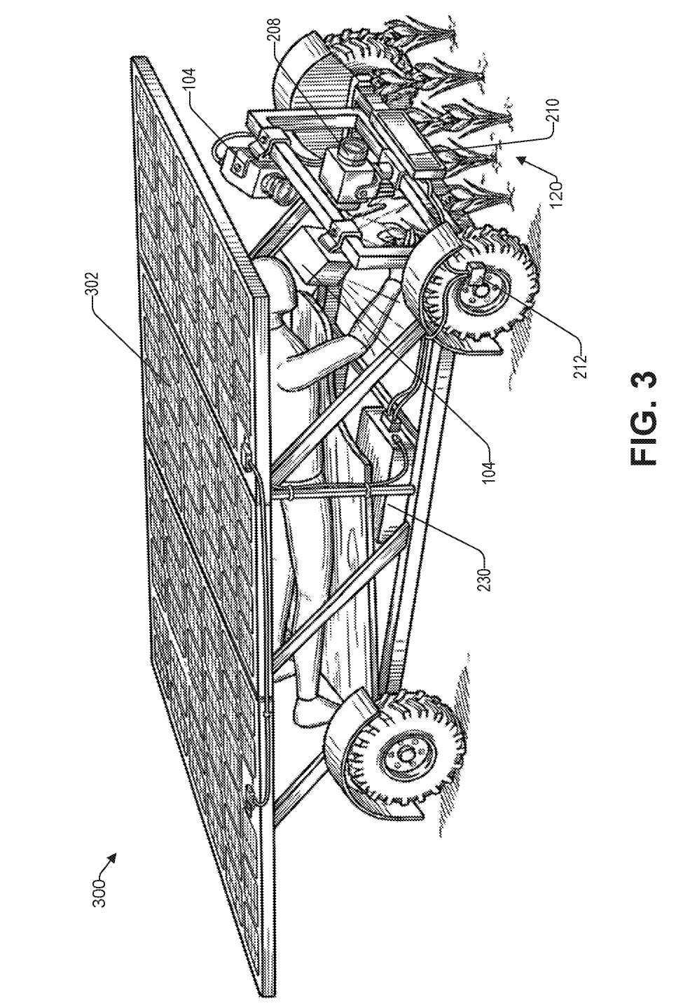

FIG. 3 illustrates an implementation of an agricultural vehicle 300 further involving an integrated solar array 302, consistent with an illustrative implementation. The solar array 302 is coupled to the mobile chassis and extends over at least a portion of the support platform. The solar array 302 is configured to perform a dual technical function: (i) capturing solar radiation for conversion into electrical energy to power the motorized drive system and the controller 230, and (ii) providing a physical barrier for protection from environmental conditions for the operator.

In some implementations, the solar array 302 involves a plurality of photovoltaic panels mounted on a tracking assembly. The tracking assembly is in communication with the controller 230 and is configured to automatically adjust an orientation of the solar array 302, such as a tilt angle or rotation, relative to the mobile chassis. The controller 230 may determine an optimal orientation for the solar array 302 based on data from the sensor system, such as a localized sun position determined via the GPS module or a light-intensity sensor. This automatic adjustment facilitates an appropriate angle relative to the sun to optimize power capture efficiency throughout an agricultural activity. Additionally, the solar array 302 serves as a weather shield, mitigating the impact of direct sunlight or precipitation on the workspace zone and the operator, thereby facilitating persistent operation in varying meteorological environments.

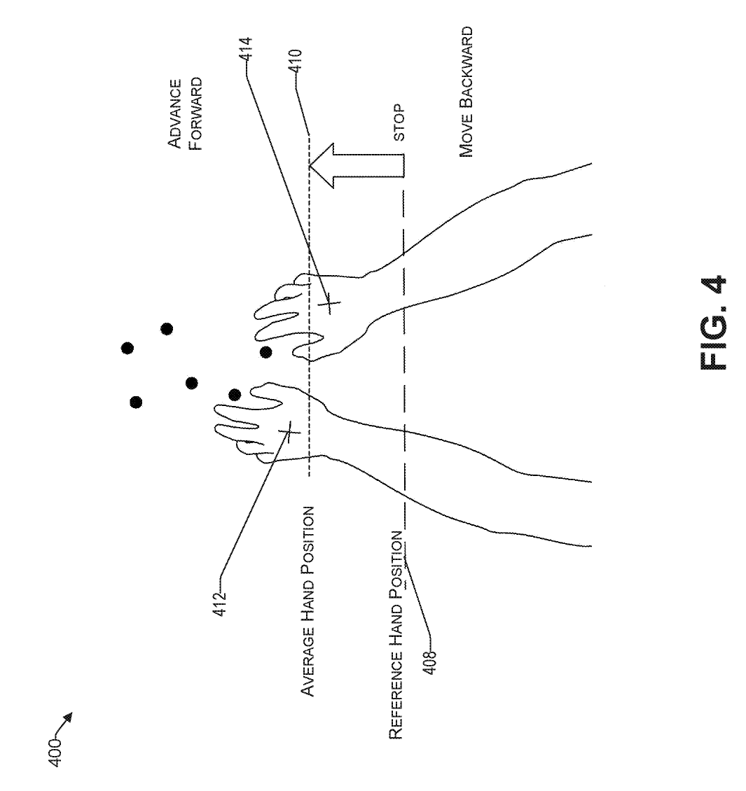

FIG. 4 is a schematic diagram illustrating the control logic 400 implemented by the controller to adjust a navigational parameter of the mobile chassis during an agricultural activity, such as harvesting operation. The diagram depicts a top-down view of the workspace zone where a user's hands are shown interacting with a plurality of subject crops (represented by the black dots), such as saffron flowers, distributed in the field.

The sensor system detects the user's hands and determines specific tracking points, such as the left hand centroid 412 and the right hand centroid 414. Based on these tracking points, the controller calculates a detected average hand position 410 (shown as "Average Hand Position"). This detected average hand position 410 is compared against a defined reference configuration 408 (shown as "Reference Hand Position"), which corresponds to a neutral zone proximate to the user's body where the chassis remains stationary (indicated by the "STOP" region). In one implementation, a time averaging of the position of the centroid of the left and/or right hand(s) is used as to represent the detected average hand position 410.

As the operator reaches forward to harvest the subject crops 120 located further away in the workspace zone, the detected average hand position 410 shifts forward relative to the reference configuration 408. The controller 230 identifies this displacement and regulates the motorized drive system to "Advance Forward." In various implementations, the velocity of this advancement is proportional to the magnitude of the displacement of the detected average hand position 410 relative to the reference configuration 408. Conversely, if the operator retracts their hands towards the body, the detected average hand position 410 returns to or behind the reference configuration 408, causing the controller 230 to stop the mobile chassis or, if displaced significantly backward, regulate a "Move Backward" operation.

In one implementation, to prevent mechanical oscillation and facilitate smooth transitions between navigational states, the controller 230 implements a hysteresis threshold (also referred to as a dead band) associated with the reference configuration 408. The hysteresis threshold defines a secondary boundary within which fluctuations of the detected average hand position 410 do not trigger a change in the navigational parameter. For example, once the mobile chassis has transitioned to an "Advance Forward" state, the controller 230 may involve the detected average hand position 410 to retreat a predetermined distance into the "STOP" region before the motorized drive system is deactivated. This logic filters out minor physiological tremors or transient (e.g., harvesting) motions, thereby mitigating rapid cycling of the motorized drive system and enhancing the stability of the vehicle's movement through the agricultural environment.

The sensor system detects the user's hands and determines specific tracking points, such as the left hand centroid 412 and/or the right hand centroid 414. Based on these tracking points, the controller calculates a detected average hand position 410 (shown as "Average Hand Position"). This detected average hand position 410 is compared against a defined reference configuration 408 (shown as "Reference Hand Position"), which corresponds to a neutral zone proximate to the user's body where the chassis remains stationary (indicated by the "STOP" region). In one implementation, a time averaging of the position of the centroid of the left and/or right hands is used as to represent the average hand position 410.

As the user reaches forward to harvest the subject crops located further away in the workspace zone, the detected average hand position 410 shifts forward relative to the reference configuration 408. The controller identifies this displacement and commands the motorized drive system to "Advance Forward." In preferred implementations, the speed of this advancement is proportional to the distance the user reaches toward the subject crops. Conversely, if the user retracts their hands towards the body (e.g., to place harvested crops in a container), the detected average hand position 410 returns to or behind the reference configuration 408, causing the controller to stop the chassis or, if displaced significantly backward, command a "Move Backward" operation.

In some implementations, the controller 230 is further configured to recognize predetermined hand gestures as discrete navigational commands. Unlike the passive tracking of the detected average hand position 410, these predetermined hand gestures provide the operator with active, intentional control over the mobile chassis for specific maneuvers. For example, the sensor system may recognize a pointing gesture, such as an index finger extending to the left, right, or forward, to trigger a corresponding change in the navigational parameter. A left-pointing gesture may regulate the motorized drive system to execute a lateral steering adjustment or a pivot toward the left, while a right-pointing gesture regulates a similar adjustment toward the right.

Furthermore, a forward-pointing gesture may serve as an override command to initiate a constant-velocity advancement mode, independent of the hand displacement relative to the reference configuration 408. This allows the operator to advance the mobile chassis through sparse crop zones without maintaining a forward reach. Other predetermined gestures, such as a raised palm, a wave, or a specific finger configuration (e.g., a "thumbs-up" signal), can be mapped to high-level commands such as an emergency stop, a "return to home" routine, or a mode-switching signal to enter or exit the agricultural activity control loop. By integrating these active gestures with the passive tracking logic, the system provides a multi-modal interface that maximizes navigational flexibility while minimizing the physical coordination typically associated with mechanical levers or pedals.

The self-driving agricultural vehicle and the associated methods of regulation provide a coordinated system where the movement of a mobile chassis is intuitively linked to the natural actions of an operator. By gathering sensor data of the spatial displacement between an portion, such as a hand, and a reference configuration, the system can adjust navigational parameters like forward velocity without requiring the operator to engage with manual controls. This passive visual servoing allows the vehicle to maintain a consistent spatial relationship with a target workspace, allowing the operator to remain in an ergonomically favorable position while performing the agricultural activity.

The system is designed to handle the complexities of a real-world agricultural environment through several robust logic layers. For instance, the controller can implement a hysteresis threshold that creates a stable dead band, preventing the motorized drive system from oscillating in response to minor or transient hand movements. Furthermore, by calculating a time-averaged position of the operator's hand(s) or determining a centroid between both hands, the system filters out physiological tremors or non-agricultural (e.g., harvesting, weeding, etc.,) motions. This facilitates the physical advancement of the vehicle to remain smooth and synchronized with the actual pace of the work.

Beyond movement control, the integration of environmental and mechanical feedback enhances the reliability of the operation. A solar array can be utilized to both power the drive system and provide a protective shield for the operator against sun or precipitation. Simultaneously, front-facing sensors can gather data for upcoming crop rows or obstacles, while wheel encoders provide odometry data that serves as a feedback loop to verify and refine speed adjustments. Together, these features create a highly responsive agricultural activity environment that reduces the cognitive and physical load on the operator, allowing for a more efficient and sustainable manual agricultural activity process.

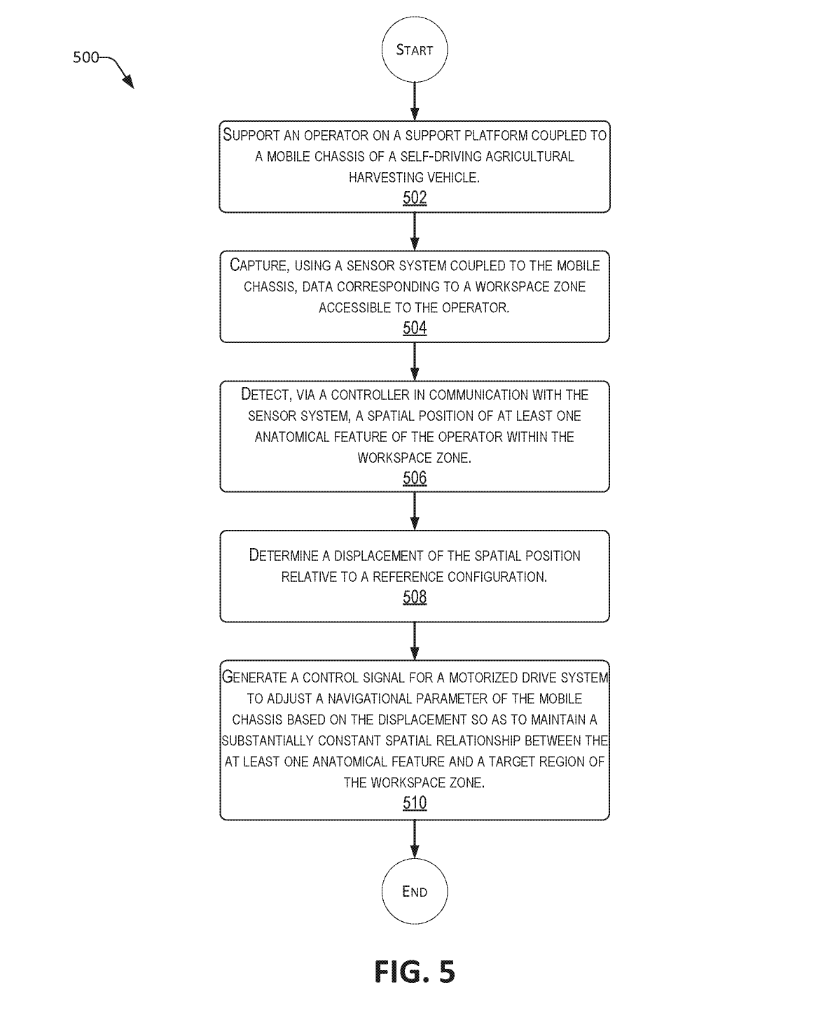

With the foregoing overview of example systems of agricultural vehicles, it may be helpful to discuss an example process. To that end, FIG. 5 illustrates a flow diagram 500 of an example method for regulating advancement of an agricultural vehicle. The method may be performed by a controller in communication with a sensor system and a motorized drive system of the vehicle.

At block 502, an operator is supported on a support platform coupled to a mobile chassis of the self-driving agricultural vehicle. The support platform is configured to position the operator relative to a workspace zone in which agricultural activity occurs.

Next, at block 504, data corresponding to the workspace zone accessible to the operator is captured via a sensor system coupled to the mobile chassis. The captured data may include spatial information associated with objects and features located within the workspace zone.

At block 506, a spatial position of at least one portion (e.g., anatomical feature) of the operator within the workspace zone is detected by the controller based on the data captured by the sensor system. The detected portion may include, for example, a hand or wrist of the operator during an agricultural activity operation.

At block 508, the controller determines a displacement of the detected spatial position relative to a reference configuration. The reference configuration may be fixed relative to the mobile chassis and serves as a baseline for assessing changes in the spatial position of the portion.

At block 510, the controller generates a control signal for a motorized drive system to adjust a navigational parameter of the mobile chassis based on the determined displacement. The navigational parameter may be adjusted such that a substantially constant spatial relationship is maintained between the at least one portion of the operator (e.g., one or more hands) and a target region of the workspace zone as the vehicle advances.

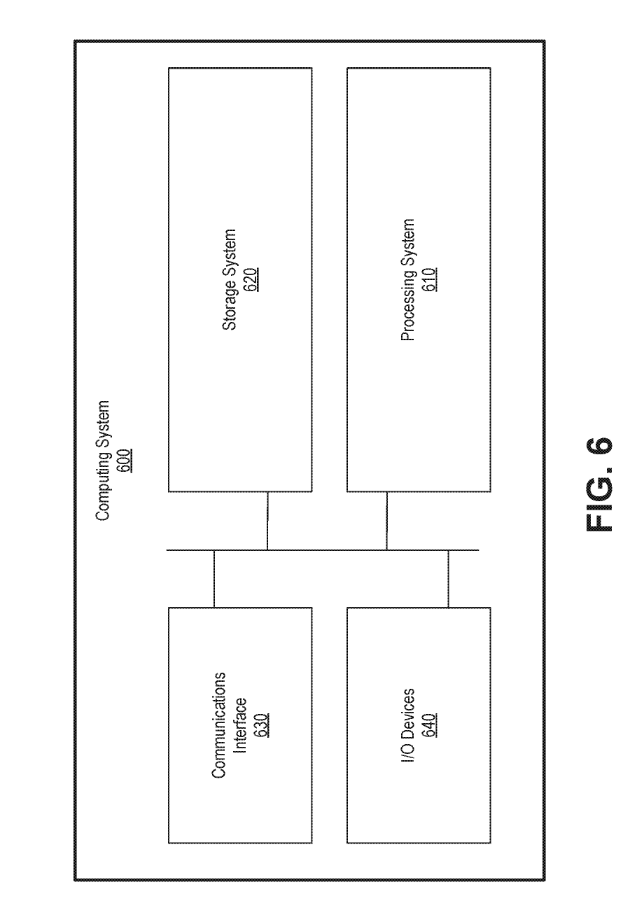

FIG. 6 illustrates an example computing system 600 that can be used to implement the systems, methods, and processes disclosed herein. In some implementations, the computing system 600 is configured to implement the controller 230 described with respect to FIGS. 1 and 2. As illustrated, the computing system 600 includes one or more processors 610, a storage system 620, a communication interface 630, and one or more input/output (I/O) interfaces 640, which may be communicatively coupled via one or more buses or interconnects. The computing system 600 may further include additional components, such as a power supply, battery, enclosure, or environmental shielding, which are omitted from the figure for clarity. In some implementations, the computing system 600 is integrated with, or in communication with, one or more sensors and actuators discussed herein.

The communication interface 630 includes circuitry configured to enable communication between the computing system 600 and external devices or subsystems. In various implementations, the communication interface 630 supports wired or wireless communication links and may include radio-frequency circuitry, network ports, or serial communication interfaces. The communication interface 630 may be configured to exchange data with sensor systems, motor controllers, positioning modules, or other vehicle subsystems using one or more communication protocols.

The one or more I/O interfaces 640 are configured to facilitate data exchange between the computing system 600 and external devices. In the context of the present application, the I/O interfaces 640 may be coupled to one or more sensor systems, including optical sensors (such as monocular cameras, stereo camera pairs, or time-of-flight cameras), front-facing environmental sensors, magnetic sensors, inertial measurement units, wheel encoders, or positioning modules. The I/O interfaces 640 may further be coupled to actuators associated with the motorized drive system to transmit control signals generated by the computing system 600.

The one or more processors 610 include circuitry configured to retrieve and execute machine-readable program instructions stored in the storage system 620. The processor 610 may be implemented as one or more general-purpose processors, microcontrollers, or system-on-chip devices, and may additionally include dedicated control logic for real-time processing. In some implementations, the processor 610 executes control algorithms for detecting spatial positions of portions of an operator, determining displacements relative to reference configurations, and generating control signals to regulate one or more navigational parameters of a mobile chassis.

The storage system 620 includes one or more non-transitory computer-readable storage media configured to store program instructions, data, and parameters used by the computing system 600. The storage system 620 may include volatile memory, nonvolatile memory, or a combination thereof. In some implementations, the storage system 620 stores control logic, filtering algorithms, hysteresis parameters, calibration data, or reference configurations used to coordinate vehicle movement with detected spatial characteristics of an operator and a workspace zone.

Upon execution by the processor 610, the program instructions stored in the storage system 620 configure the computing system 600 to operate as a special-purpose controller for a self-driving agricultural vehicle. In particular, execution of the program instructions causes the computing system 600 to process sensor data, determine spatial relationships between an operator and a target workspace, and generate control signals for a motorized drive system to regulate advancement of the mobile chassis in a manner synchronized with activity. This execution transforms the computing system 600 from a general-purpose computing device into a controller configured to implement the vehicle control functions described herein.

According to one implementation, an agricultural vehicle includes a mobile chassis including a motorized drive system configured to traverse an agricultural environment, a support platform coupled to the mobile chassis and configured to support an operator during an agricultural activity, a sensor system coupled to the mobile chassis and configured to capture data corresponding to a workspace zone accessible to the operator, and a controller in communication with the motorized drive system and the sensor system, the controller being configured to detect, via the sensor system, a spatial position of at least one portion of the operator within the workspace zone, determine a displacement of the spatial position relative to a reference configuration, and generate a control signal for the motorized drive system to adjust a navigational parameter of the mobile chassis based on the displacement to maintain a substantially constant spatial relationship between the at least one portion and a target region of the workspace zone.

In one implementation, the support platform is configured to support the operator in a prone position.

In one implementation, the reference configuration is fixed relative to the mobile chassis.

In one implementation, the controller is configured to determine the displacement by a predetermined amount.

In one implementation, the controller is further configured to determine the displacement relative to a spatial position of a subject crop being harvested.

In one implementation, the controller is further configured to implement a hysteresis threshold associated with the reference configuration, the hysteresis threshold defining a boundary within which fluctuations of the spatial position of the at least one portion do not result in an adjustment of the navigational parameter.

In one implementation, the spatial position of the at least one portion includes a detected average hand position over a predetermined time period.

In one implementation, the detected average hand position is derived from a calculated centroid of a first hand and a second hand of the operator.

In one implementation, the navigational parameter includes a forward velocity of the mobile chassis, and the controller is configured to regulate the forward velocity to be proportional to a magnitude of the displacement.

In one implementation, the sensor system includes at least one of an optical camera, a stereo camera pair, a time-of-flight sensor, or a magnetic field sensor.

In one implementation, the agricultural vehicle further includes a wheel encoder coupled to the motorized drive system and in communication with the controller, wherein the controller is configured to utilize odometry data from the wheel encoder as a feedback signal to verify the adjustment of the navigational parameter.

According to one implementation, a method for regulating the advancement of an agricultural vehicle includes supporting an operator via a support platform coupled to a mobile chassis, capturing, via a sensor system coupled to the mobile chassis, data corresponding to a workspace zone accessible to the operator, detecting, via a controller in communication with the sensor system, a spatial position of at least one portion of the operator within the workspace zone, determining a displacement of the spatial position relative to a reference configuration, and generating a control signal for a motorized drive system to adjust a navigational parameter of the mobile chassis based on the displacement to maintain a substantially constant spatial relationship between the at least one portion and a target region of the workspace zone.

In one implementation, the reference configuration is fixed relative to the mobile chassis.

In one implementation, the method further includes implementing a hysteresis threshold associated with the reference configuration to define a boundary within which fluctuations of the spatial position of the at least one portion do not result in an adjustment of the navigational parameter.

In one implementation, detecting the spatial position includes calculating a detected average hand position over a predetermined time period.

In one implementation, calculating the detected average hand position includes determining a centroid of a first hand and a second hand of the operator.

In one implementation, the navigational parameter includes a forward velocity, and generating the control signal includes regulating the forward velocity to be proportional to a magnitude of the displacement.

In one implementation, the method further includes capturing image data forward of the mobile chassis via a front-facing sensor to identify at least one of a crop row, a landmark, or an obstacle.

In one implementation, the method further includes capturing, via a solar array coupled to the mobile chassis, solar radiation to power the motorized drive system while providing environmental shielding for the operator.

According to one implementation, a non-transitory computer-readable storage medium stores instructions that, when executed by one or more processors of a controller of an agricultural vehicle, cause the controller to support an operator via a support platform coupled to a mobile chassis, capture, via a sensor system coupled to the mobile chassis, data corresponding to a workspace zone accessible to the operator, detect a spatial position of at least one portion of the operator within the workspace zone, determine a displacement of the spatial position relative to a reference configuration, and generate a control signal for a motorized drive system to adjust a navigational parameter of the mobile chassis based on the displacement to maintain a substantially constant spatial relationship between the at least one portion and a target region of the workspace zone.

While some features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the salient tasks may be stored in a machine or computer readable medium such as a storage medium. A processor(s) may perform the relevant tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system’s registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. An agricultural vehicle, comprising:
a mobile chassis comprising a motorized drive system configured to traverse an agricultural environment;
a support platform coupled to the mobile chassis and configured to support an operator during an agricultural activity;
a sensor system coupled to the mobile chassis and configured to capture data corresponding to a workspace zone accessible to the operator; and
a controller in communication with the motorized drive system and the sensor system, the controller configured to:
detect, via the sensor system, a spatial position of at least one portion of the operator within the workspace zone;
determine a displacement of the spatial position relative to a reference configuration; and
generate a control signal for the motorized drive system to adjust a navigational parameter of the mobile chassis based on the displacement to maintain a spatial relationship between the at least one portion and a target region of the workspace zone.

2. The agricultural vehicle of claim 1, further comprising a support platform coupled to the mobile chassis and configured to support an operator in a prone position during an agricultural activity.

3. The agricultural vehicle of claim 1, wherein the reference configuration is fixed relative to the mobile chassis.

4. The agricultural vehicle of claim 1, wherein the controller is configured to determine the displacement by a predetermined amount.

5. The agricultural vehicle of claim 1, wherein the controller is further configured to determine the displacement relative to a spatial position of a subject crop being harvested.

6. The agricultural vehicle of claim 1, wherein the controller is further configured to implement a hysteresis threshold associated with the reference configuration, the hysteresis threshold defining a boundary within which fluctuations of the spatial position of the at least one portion do not result in an adjustment of the navigational parameter.

7. The agricultural vehicle of claim 1, wherein the spatial position of the at least one portion comprises a detected average hand position over a predetermined time period.

8. The agricultural vehicle of claim 7, wherein the detected average hand position is derived from a calculated centroid of a first hand and a second hand of the operator.

9. The agricultural vehicle of claim 1, wherein the navigational parameter comprises a forward velocity of the mobile chassis, and wherein the controller is configured to regulate the forward velocity to be proportional to a magnitude of the displacement.

10. The agricultural vehicle of claim 1, wherein the sensor system comprises at least one of an optical camera, a stereo camera pair, a time-of-flight sensor, or a magnetic field sensor.

11. The agricultural vehicle of claim 1, further comprising a wheel encoder coupled to the motorized drive system and in communication with the controller, wherein the controller is configured to utilize odometry data from the wheel encoder as a feedback signal to verify the adjustment of the navigational parameter.

12. A method for regulating an advancement of an agricultural vehicle, the method comprising:
capturing, via a sensor system coupled to a mobile chassis, data corresponding to a workspace zone accessible to an operator;
detecting, via a controller in communication with the sensor system, a spatial position of at least one portion of the operator within the workspace zone;
determining a displacement of the spatial position relative to a reference configuration; and
generating a control signal for a motorized drive system to adjust a navigational parameter of the mobile chassis based on the displacement to maintain a spatial relationship between the at least one portion and a target region of the workspace zone.

13. The method of claim 12, wherein the reference configuration is fixed relative to the mobile chassis.

14. The method of claim 12, further comprising implementing a hysteresis threshold associated with the reference configuration to define a boundary within which fluctuations of the spatial position of the at least one portion do not result in an adjustment of the navigational parameter.

15. The method of claim 12, wherein detecting the spatial position involves calculating a detected average hand position over a predetermined time period.

16. The method of claim 15, wherein calculating the detected average hand position involves determining a centroid of a first hand and a second hand of the operator.

17. The method of claim 12, wherein the navigational parameter comprises a forward velocity, and wherein generating the control signal involves regulating the forward velocity to be proportional to a magnitude of the displacement.

18. The method of claim 12, further comprising capturing image data forward of the mobile chassis via a front-facing sensor to identify at least one of a crop row, a landmark, or an obstacle.

19. The method of claim 12, further comprising capturing, via a solar array coupled to the mobile chassis, solar radiation to power the motorized drive system while providing environmental shielding for the operator.

20. A non-transitory computer-readable storage medium storing instructions that, upon execution by one or more processors of a controller of an agricultural vehicle, cause the controller to:
capture, via a sensor system coupled to a mobile chassis, data corresponding to a workspace zone accessible to an operator;
detect a spatial position of at least one portion of the operator within the workspace zone;
determine a displacement of the spatial position relative to a reference configuration; and
generate a control signal for a motorized drive system to adjust a navigational parameter of the mobile chassis based on the displacement to maintain a spatial relationship between the at least one portion and a target region of the workspace zone.
